(19) United States
(12) Patent Application Publication
(10) Pub. No.: US 2026/0329110 A1
(43) Pub. Date: Oct. 22, 2026

(54) LIQUID CRYSTAL PRISM AND DISPLAY DEVICE

(71) Applicant: SHANGHAI TIANMA MICROELECTRONICS CO., LTD., Shanghai (CN)

(72) Inventors: Feng LU, Shanghai (CN); Yaodong WU, Shanghai (CN)

(73) Assignee: SHANGHAI TIANMA MICROELECTRONICS CO., LTD., Shanghai (CN)

(21) Appl. No.: 19/699,020

(22) Filed: Jun. 5, 2026

(30) Foreign Application Priority Data
Feb. 25, 2026 (CN) 202610226312.7

(51) Int. Cl. G02B 30/28; G02F 1/1335; G02F 1/1343; G02F 1/1345

(52) U.S. Cl. CPC G02B 30/28; G02F 1/133526; G02F 1/134309; G02F 1/13452

(57) ABSTRACT

Provided are a liquid crystal prism. The liquid crystal prism includes an optical region and a non-optical region. The non-optical region includes a first bezel region, and bonding pads are disposed in the first bezel region. The liquid crystal prism includes a substrate, multiple electrode groups and a lead group. Each of the multiple electrode groups includes multiple drive electrodes. The multiple drive electrodes are located in the optical region and the non-optical region. The lead group is located in the non-optical region and includes multiple leads. The multiple drive electrodes and the multiple leads are disposed in different layers. The liquid crystal prism further includes an auxiliary lead group. At least a portion of the auxiliary lead group is located in the first bezel region. The auxiliary lead group includes multiple auxiliary leads. The multiple leads are electrically connected to the bonding pads via the multiple auxiliary leads, respectively.

### CROSS-REFERENCE TO RELATED APPLICATION

This application claims priority to Chinese Patent Application No. 202610226312.7, filed with the China National Intellectual Property Administration (CNIPA) on Feb. 25, 2026, the disclosure of which is incorporated herein by reference in its entirety.

### TECHNICAL FIELD

The present disclosure relates to the field of display technology and, in particular, to a liquid crystal prism and a display device.

### BACKGROUND

At present, in a current three-dimensional (3D) display device, a periodic electric field is formed in a liquid crystal cell so that an equivalent cylindrical prism is formed in a liquid crystal prism and the liquid crystal prism implements an optical splitting function. As a result, the 3D display device works in a 3D mode, and human eyes can see a 3D image. When a voltage of a drive electrode in the liquid crystal prism is switched so that no equivalent cylindrical prism is formed in the liquid crystal prism, the liquid crystal prism has no optical splitting function. As a result, the 3D display device works in a two-dimensional (2D) mode, and human eyes can see a 2D image. A bonding pad of a liquid crystal prism in the related art has a fixed position.

### SUMMARY

The present disclosure provides a liquid crystal prism and a display device to improve the flexibility of a position of a bonding pad.

According to an aspect of the present disclosure, a liquid crystal prism is provided. The liquid crystal prism includes an optical region and a non-optical region located at a periphery of the optical region, where the non-optical region includes a first bezel region located on one side of the optical region, and bonding pads are disposed in the first bezel region.

The liquid crystal prism includes a substrate, multiple electrode groups and a lead group, the multiple electrode groups and the lead group are located on one side of the substrate, at least one of the multiple electrode groups includes multiple drive electrodes, the multiple drive electrodes are located in the optical region and the non-optical region, the lead group is located in the non-optical region and includes multiple leads, the multiple drive electrodes and the multiple leads are disposed in different layers, one of the multiple drive electrodes is electrically connected to at least one of the multiple leads, and different drive electrodes are electrically connected to different leads.

The liquid crystal prism further includes an auxiliary lead group, at least a portion of the auxiliary lead group is located in the first bezel region, the auxiliary lead group includes multiple auxiliary leads, and the multiple leads are electrically connected to the bonding pads via the multiple auxiliary leads, respectively.

According to another aspect of the present disclosure, a display device is provided. The display device includes a display panel and the liquid crystal prism.

It is to be understood that the content described in this section is neither intended to identify key or critical features of embodiments of the present disclosure nor intended to limit the scope of the present disclosure. Other features of the present disclosure become easily understood through the description provided below.

### BRIEF DESCRIPTION OF DRAWINGS

To illustrate technical solutions in the embodiments of the present disclosure more clearly, drawings used in the description of the embodiments are briefly described below. Apparently, the drawings described below illustrate some embodiments of the present disclosure, and those of ordinary skill in the art may obtain other drawings based on the drawings described below on the premise that no creative work is done.

FIG. 1 is a structural diagram of a liquid crystal prism.

FIG. 2 is a structural diagram of a first liquid crystal prism according to an embodiment of the present disclosure.

FIG. 3 is an enlarged view of the position 61 in FIG. 2.

FIG. 4 is an enlarged view of the position A in FIG. 2.

FIG. 5 is a first sectional view taken along AA′ in FIG. 4.

FIG. 6 is a second sectional view taken along AA′ in FIG. 4.

FIG. 7 is a structural diagram of a second liquid crystal prism according to an embodiment of the present disclosure.

FIG. 8 is a structural diagram of a third liquid crystal prism according to an embodiment of the present disclosure.

FIG. 9 is a structural diagram of a fourth liquid crystal prism according to an embodiment of the present disclosure.

FIG. 10 is a sectional view taken along BB′ in FIG. 9.

FIG. 11 is a structural diagram of a fifth liquid crystal prism according to an embodiment of the present disclosure.

FIG. 12 is a structural diagram of a sixth liquid crystal prism according to an embodiment of the present disclosure.

FIG. 13 is a structural diagram of a seventh liquid crystal prism according to an embodiment of the present disclosure.

FIG. 14 is a structural diagram of an eighth liquid crystal prism according to an embodiment of the present disclosure.

FIG. 15 is a first enlarged view of the position B in FIG. 2.

FIG. 16 is a second enlarged view of the position B in FIG. 2.

FIG. 17 is a structural diagram of a ninth liquid crystal prism according to an embodiment of the present disclosure.

FIG. 18 is an enlarged view of the position C in FIG. 17.

FIG. 19 is an enlarged view of the position D in FIG. 17.

FIG. 20 is a structural diagram of a tenth liquid crystal prism according to an embodiment of the present disclosure.

FIG. 21 is an enlarged view of the position E in FIG. 20.

FIG. 22 is a structural diagram of an eleventh liquid crystal prism according to an embodiment of the present disclosure.

FIG. 23 is an enlarged view of the position F in FIG. 22.

FIG. 24 is a structural diagram of a twelfth liquid crystal prism according to an embodiment of the present disclosure.

FIG. 25 is an enlarged view of the position G in FIG. 24.

FIG. 26 is a structural diagram of a thirteenth liquid crystal prism according to an embodiment of the present disclosure.

FIG. 27 is a sectional view taken along CC′ in FIG. 26.

FIG. 28 is a structural diagram of a display device according to an embodiment of the present disclosure.

FIG. 29 is a structural diagram of a display panel according to an embodiment of the present disclosure.

### DETAILED DESCRIPTION

To make the technical solutions of the present disclosure better understood by those skilled in the art, the technical solutions in the embodiments of the present disclosure are described below clearly and completely in conjunction with the drawings in the embodiments of the present disclosure. Apparently, the embodiments described below are part, not all, of embodiments of the present disclosure. Based on the embodiments of the present disclosure, all other embodiments obtained by those of ordinary skill in the art are within the scope of the present disclosure on the premise that no creative work is done.

It is to be noted that terms such as “first” and “second” in the description, claims, and drawings of the present disclosure are used for distinguishing between similar objects and are not necessarily used for describing a particular order or sequence. It is to be understood that data used in this manner are interchangeable where appropriate so that the embodiments of the present disclosure described herein can be implemented in an order not illustrated or described herein. In addition, the terms “including”, “having”, and any variations thereof are intended to encompass a non-exclusive inclusion. For example, a process, method, system, product, or apparatus that includes a series of steps or units may include not only the expressly listed steps or units but also other steps or units that are not expressly listed or are inherent to such a process, method, product, or apparatus.

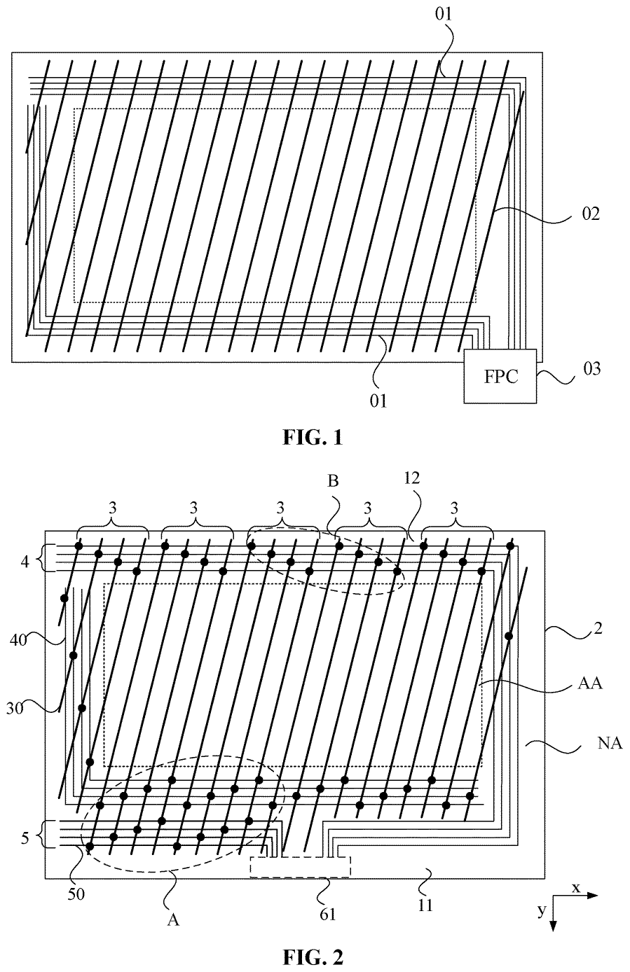

FIG. 1 is a structural diagram of a liquid crystal prism. As shown in FIG. 1, a lead 01 in the liquid crystal prism can be electrically connected to a drive electrode 02. The lead 01 is used for leading out the drive electrode 02 and is connected to a flexible printed circuit 03, and the flexible printed circuit (FPC) 03 is electrically connected to a driver circuit of the drive electrode 02. A single-layer metal is generally used in the lead 01, which cannot achieve the intersection between leads 01. A bonding pad is not shown in FIG. 1. The bonding pad is disposed on a substrate of the liquid crystal prism, and the flexible printed circuit 03 is bonded to and electrically connected to the bonding pad. If the flexible printed circuit 03 is moved to a center position of a lower bezel, a relatively long distance of the lead 01 needs to be added, resulting in an increase in resistance. Generally, the flexible printed circuit 03 is bonded at a corner position of the substrate of the liquid crystal prism. The bonding pad of the liquid crystal prism has a fixed position. When the flexible printed circuit is bonded to the bonding pad, a pressure on the substrate of the liquid crystal prism is concentrated at the corner position, resulting in an uneven pressure and a bonding risk during the bonding of the flexible printed circuit 03.

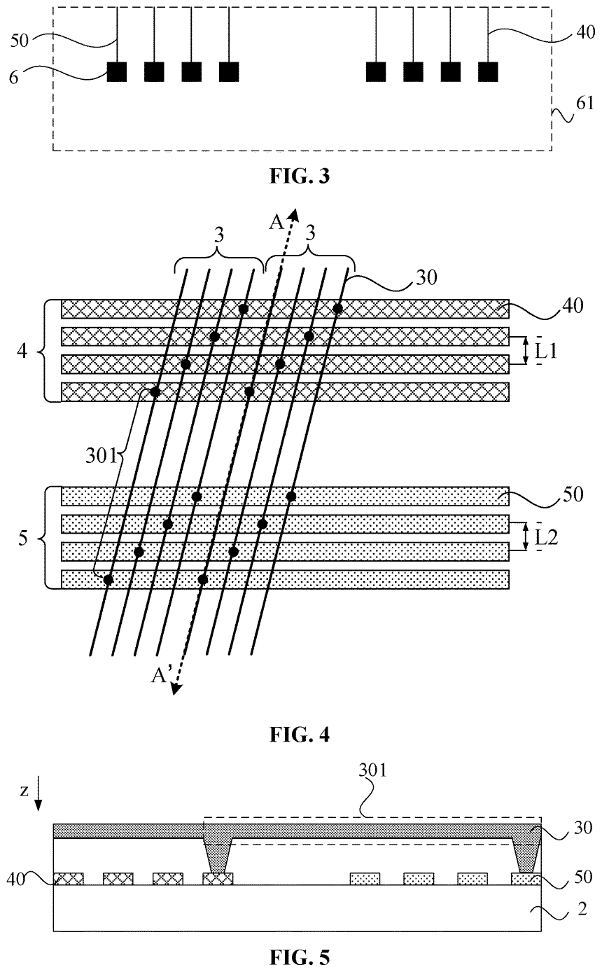

An embodiment of the present disclosure provides a liquid crystal prism. FIG. 2 is a structural diagram of a first liquid crystal prism according to an embodiment of the present disclosure. FIG. 3 is an enlarged view of the position 61 in FIG. 2. FIG. 4 is an enlarged view of the position A in FIG. 2. FIG. 5 is a first sectional view taken along AA′ in FIG. 4. In conjunction with FIGS. 2, 3, 4 and 5, the liquid crystal prism includes an optical region AA and a non-optical region NA located at a periphery of the optical region AA, the non-optical region NA includes a first bezel region 11 located on one side of the optical region AA, and bonding pads 6 are disposed in the first bezel region 11; the liquid crystal prism includes a substrate 2, multiple electrode groups 3 and a lead group 4, the multiple electrode groups 3 and the lead group 4 are located on one side of the substrate 2, each electrode group 3 includes multiple drive electrodes 30 (in this embodiment, the electrode group 3 including four drive electrodes 30 is used as an example for illustration, which is not a limitation on the number of drive electrodes 30, for example, the electrode group 3 may include 6 to 30 drive electrodes 30), and the drive electrodes 30 are located in the optical region AA and the non-optical region NA; the same drive electrode 30 is located in both the optical region AA and the non-optical region NA. The lead group 4 is located in the non-optical region NA and includes multiple leads 40, and the drive electrodes 30 and the leads 40 are disposed in different layers. One drive electrode 30 is electrically connected to at least one lead 40, and different drive electrodes 30 are electrically connected to different leads 40. The liquid crystal prism further includes an auxiliary lead group 5, at least a portion of the auxiliary lead group 5 is located in the first bezel region 11, the auxiliary lead group 5 includes multiple auxiliary leads 50, and the leads 40 are electrically connected to the bonding pads 6 via the auxiliary leads 50, respectively.

In the liquid crystal prism, an arrangement direction of liquid crystal molecules is adjusted by an electric field, thereby changing a light transmission path. In the liquid crystal prism, the optical region AA may be a region that directly participates in light modulation, and the non-optical region NA may be a region that does not directly participate in light modulation. The optical region AA includes a region of optical functions, such as an optical splitting function. The non-optical region NA includes a region of non-optical functions, and electrical performance elements such as the lead 40, instead of optical performance elements, may be disposed in the non-optical region NA. For example, the optical region AA is a region corresponding to a display region of a display panel in the liquid crystal prism for optically modulating light emitted from the display panel. The non-optical region NA is a region corresponding to a non-display region of the display panel in the liquid crystal prism. To ensure a display effect, the non-optical region NA is at the periphery of the optical region AA. The first bezel region 11 of the non-optical region NA is located on one side of the optical region AA. FIG. 2 only illustrates a position of a region 61 where the bonding pad 6 is located, but does not specifically illustrate the bonding pad 6. FIG. 3 illustrates that the region 61 where the bonding pad 6 is located includes the bonding pad 6. In conjunction with FIGS. 2 and 3, the first bezel region 11 includes the region 61 where the bonding pad 6 is located, and the region 61 where the bonding pad 6 is located includes the bonding pad 6. The bonding pad 6 can be used for being electrically connected to a signal line in the liquid crystal prism. In some embodiments, the flexible printed circuit can be bonded in the liquid crystal prism by the bonding pad 6.

Multiple electrode groups 3 and at least one lead group 4 are disposed on one side of the substrate 2. The electrode group 3 of the liquid crystal prism includes multiple drive electrodes 30, and the drive electrode 30 can be used for controlling an orientation of the liquid crystal molecules. The lead group 4 of the liquid crystal prism can be used for achieving an electrical connection between the drive electrode 30 and an external control circuit. The lead group 4 includes multiple leads 40, and the lead 40 is located in the non-optical region NA. Since both the drive electrode 30 and the lead 40 can play a role in electric signal transmission, the drive electrode 30 and the lead 40 need to be disposed in different layers to prevent an unintended electrical connection between the drive electrode 30 and the lead 40, and a connection via (referred to as via for short) is provided at a position where an electrical connection between the drive electrode 30 and the lead 40 is intended to ensure the normal working of the liquid crystal prism. To ensure that the lead 40 can provide signals or receive signals for all drive electrodes 30, one drive electrode 30 is set to be electrically connected to at least one lead 40. Different drive electrodes 30 are electrically connected to different leads 40 so that different leads 40 can transmit different signals to different drive electrodes 30 in the same electrode group 3 or receive signals from different drive electrodes 30 in the same electrode group 3 using different leads 40. Multiple drive electrodes 30 that receive the same signal can be connected to the same lead 40, that is, multiple drive electrodes 30 that receive the same signal are connected in parallel.

The auxiliary lead group 5 in the liquid crystal prism includes multiple auxiliary leads 50, and the auxiliary lead 50 can be used for connecting the lead 40 in the lead group 4 to the bonding pad 6. Since the lead group 4 needs to be electrically connected to the bonding pad 6, the auxiliary lead 50 may be used as an epitaxial wire of the lead 40, thereby making a position where the bonding pad 6 is disposed more flexible.

For example, in conjunction with FIGS. 2, 3, 4 and 5, the liquid crystal prism includes the optical region AA and the non-optical region NA, the drive electrode 30 is located in the optical region AA and the non-optical region NA, and one side of the non-optical region NA is the first bezel region 11; the lead group 4 is disposed in the non-optical region NA, the lead 40 in the lead group 4 is disposed around the optical region AA, and each drive electrode 30 has a corresponding lead 40 which is electrically connected to the drive electrode 30; in the same electrode group 3, different drive electrodes 30 are electrically connected to different leads 40; the auxiliary lead group 5 is disposed in the first bezel region 11 and located on a side of the lead group 4 in the first bezel region 11 facing away from the optical region AA, the auxiliary lead 50 in the auxiliary lead group 5 is electrically connected to the lead 40 in the first bezel region 11, the bonding pad 6 is disposed at the middle position of the first bezel region 11, and the auxiliary lead 50 is electrically connected to the bonding pad 6. Due to the presence of the auxiliary lead group 5, the bonding pad 6 can be moved to any position of the first bezel region 11. In this manner, a bonding risk is reduced during a subsequent connection between the bonding pad 6 and the flexible printed circuit.

In the technical solution of the embodiment of the present disclosure, the auxiliary lead group 5 is disposed in the liquid crystal prism, the auxiliary lead 50 in the auxiliary lead group 5 is used as an epitaxial wire of the lead 40, and the lead 40 is connected to the bonding pad 6 via the auxiliary lead 50. Since a connection position of the auxiliary lead 50 and the bonding pad 6 is flexible, a position where the bonding pad 6 is disposed is flexible, for example, the bonding pad 6 may be disposed at the middle position of the first bezel region 11, thereby reducing a bonding risk during a subsequent connection between the bonding pad 6 and a flexible printed circuit in a hot pressing manner.

Optionally, with continued reference to FIG. 5, the auxiliary leads 50 and the leads 40 are disposed in the same layer.

The auxiliary lead 50 and the lead 40 may be made of the same material and formed in the same process so that an additional process does not need to be set for the auxiliary lead 50 and the number of processes is reduced.

Optionally, with continued reference to FIG. 5, a portion of a drive electrode 30 located in the first bezel region 11 includes a bridge 301, one end of the bridge 301 is electrically connected to a lead 40, and the other end of the bridge 301 is electrically connected to an auxiliary lead 50.

The bridge 301 can be used for achieving an electrical connection between the lead 40 and the auxiliary lead 50. One end of the bridge 301 is electrically connected to the lead 40 disposed in a different layer via a via, and the other end of the bridge 301 is electrically connected to the auxiliary lead 50 disposed in a different layer via a via.

For example, the auxiliary lead 50 and the lead 40 are disposed in the same layer and both disposed on one side of the substrate 2, and the drive electrode 30 is disposed on a side of the lead 40 facing away from the substrate 2. A portion of the drive electrode 30 extending to the first bezel region 11 is used as the bridge 301. One end of the bridge 301 is electrically connected to the lead 40 via a via, and the other end of the bridge 301 is electrically connected to the auxiliary lead 50 via a via, thereby achieving the electrical connection between the auxiliary lead 50 and the lead 40 through the bridge 301.

In the technical solution of the embodiment of the present disclosure, the drive electrode in the first bezel region includes the bridge 301 so that the electrical connection between the auxiliary lead 50 and the lead 40 is achieved through the bridge 301.

Optionally, FIG. 6 is a second sectional view taken along AA′ in FIG. 4. As shown in FIG. 6, in a direction perpendicular to the substrate 2, a layer where the drive electrode 30 is located is located between the substrate 2 and a layer where the lead 40 is located.

For example, with continued reference to FIG. 6, the direction perpendicular to the substrate 2 may be a z direction, the drive electrode 30 is prepared on one side of the substrate 2, an isolation layer is prepared on a side of the drive electrode 30 facing away from the substrate 2, vias are provided at positions of the isolation layer corresponding to two ends of the bridge 301, a lead layer is prepared on a side of the isolation layer facing away from the drive electrode 30, and the lead layer is etched to form the lead 40 and the auxiliary lead 50. The lead 40 is electrically connected to the bridge 301 via a via, and the auxiliary lead 50 is electrically connected to the bridge 301 via a via, thereby achieving the electrical connection between the lead 40 and the auxiliary lead 50.

In the technical solution of the embodiment of the present disclosure, the lead 40 and the auxiliary lead 50 are disposed on the side of the drive electrode 30 facing away from the substrate 2 so that the lead 40 plays a role in protecting the drive electrode 30.

Optionally, with continued reference to FIG. 5, in a direction perpendicular to the substrate 2, a layer where the lead 40 is located is located between the substrate 2 and a layer where the drive electrode 30 is located.

For example, the direction perpendicular to the substrate 2 may be a z direction, a lead layer is prepared on one side of the substrate 2, the lead layer is etched to form the lead 40 and the auxiliary lead 50, an isolation layer is prepared on a side of the lead layer facing away from the substrate 2, the isolation layer is provided with vias, and the drive electrode 30 is prepared on a side of the isolation layer facing away from the lead layer. A portion of the drive electrode 30 served as the bridge 301 is separately electrically connected to the lead 40 and the auxiliary lead 50 via the vias.

In some embodiments, the drive electrode 30 can be prepared using a transparent metal oxide material. The transparent metal oxide material includes, for example, indium tin oxide. The lead 40 and the auxiliary lead 50 can be prepared using a metal material, and the opaque lead 40 and the auxiliary lead 50 may be used as alignment marks in a process of etching the transparent metal oxide material layer to form the drive electrode 30 so that an additional alignment mark does not need to be disposed.

In the technical solution of the embodiment of the present disclosure, the drive electrode 30 is disposed on the side of the lead 40 and the auxiliary lead 50 facing away from the substrate 2. When the drive electrode 30 is a transparent metal electrode, the prepared lead 40 and auxiliary lead 50 can play an auxiliary role in preparing a pattern of the drive electrode 30 due to the fact that the prepared lead 40 and auxiliary lead 50 are opaque metals, which helps to improve preparation efficiency.

Optionally, with continued reference to FIGS. 2 and 4, one drive electrode 30 is electrically connected to at least one auxiliary lead 50, and different drive electrodes 30 in the same electrode group 3 are electrically connected to different auxiliary leads 50.

Since one drive electrode 30 is electrically connected to at least one lead 40, to ensure the connection between the lead 40 and the auxiliary lead 50, one drive electrode 30 is electrically connected to at least one auxiliary lead 50.

To enable each different drive electrode 30 in the same electrode group 3 to be led out to the bonding pad 6, the number of auxiliary leads 50 is set to be not less than the number of drive electrodes 30 in the electrode group 3, that is, different drive electrodes 30 in the same electrode group 3 are electrically connected to different auxiliary leads 50.

For example, the electrode group 3 includes four different drive electrodes 30. In each of the four different drive electrodes 30, one end is connected to a respective one of four different leads 40 in the lead group 4, and the other end is connected to a respective one of four different auxiliary leads 50.

In the technical solution of the embodiment of the present disclosure, one drive electrode 30 is set to be electrically connected to at least one auxiliary lead 50, and different drive electrodes 30 in the same electrode group 3 are set to be electrically connected to different auxiliary leads 50, thereby ensuring that all drive electrodes 30 in the same electrode group 3 can be led out to the bonding pads 6 to achieve signal transmission and reception.

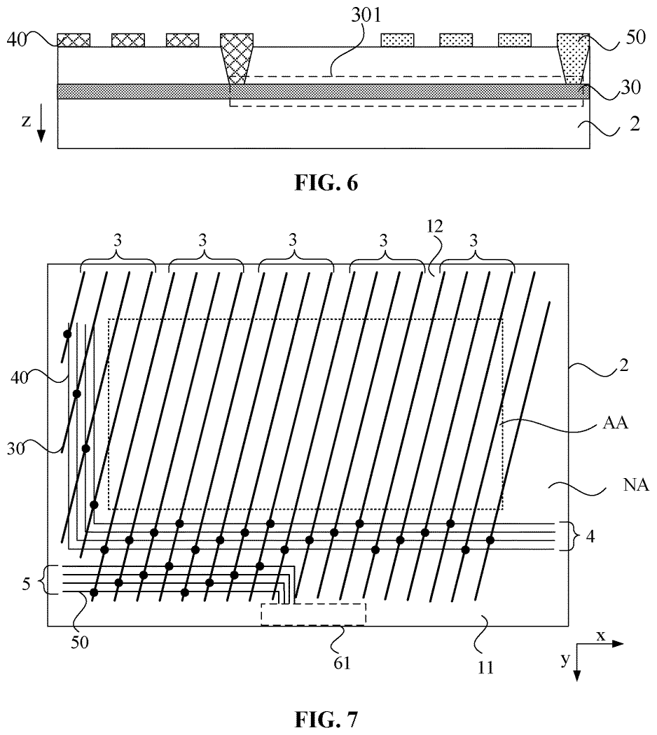

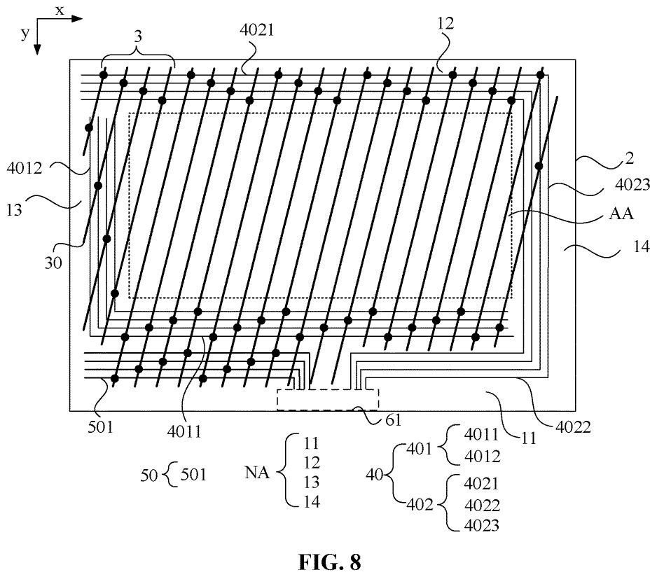

Optionally, FIG. 7 is a structural diagram of a second liquid crystal prism according to an embodiment of the present disclosure. In conjunction with FIGS. 2, 4 and 7, the non-optical region NA further includes a second bezel region 12 located on a side of the optical region AA facing away from the first bezel region 11 along a first direction y; a lead 40 is electrically connected to a portion of a drive electrode 30 located in the first bezel region 11, and/or a lead 40 is electrically connected to a portion of the drive electrode 30 located in the second bezel region 12; in the first bezel region 11, the auxiliary lead group 5 is located between at least one lead group 4 and a region 61 where the bonding pads 6 are located along the first direction y.

Both the second bezel region 12 and the first bezel region 11 are non-optical regions NA and are located on two sides of the optical region AA along the first direction y, respectively.

Since the drive electrode 30 is located in the optical region AA and the non-optical region NA and a position in the non-optical region NA where the drive electrode 30 is located may be the first bezel region 11 and/or the second bezel region 12, when the lead 40 is connected to only one end of the drive electrode 30, the lead 40 may be electrically connected to the portion of the drive electrode 30 located in the first bezel region 11, or the lead 40 may be electrically connected to the portion of the drive electrode 30 located in the second bezel region 12. The lead 40 may also be connected to both ends of the drive electrode 30 to lead signals from both ends of the drive electrode 30 out to the bonding pad 6. The lead 40 needs to be electrically connected to the portion of the drive electrode 30 located in the first bezel region 11 and needs to be electrically connected to the portion of the drive electrode 30 located in the second bezel region 12.

Since the auxiliary lead 50 is used as the epitaxial wire of the lead 40, to ensure the flexibility of the position where the bonding pad 6 is disposed, when the lead 40 is electrically connected to the portion of the drive electrode 30 located in the first bezel region 11 or electrically connected to the portion of the drive electrode 30 located in the second bezel region 12, the auxiliary lead group 5 leads some leads 40 in the lead group 4 out to the bonding pad 6. To reduce a wiring path as much as possible, the auxiliary lead group 5 is disposed between the lead group 4 and the bonding pad 6.

To ensure the flexibility of the position where the bonding pad 6 is disposed, when the lead 40 is electrically connected to the portion of the drive electrode 30 located in the first bezel region 11 and electrically connected to the portion of the drive electrode 30 located in the second bezel region 12 and the bonding pad 6 is located in the first bezel region 11, the auxiliary lead group 5 needs to be disposed at least between the lead group 4 connected to the drive electrode 30 in the first bezel region 11 and the bonding pad 6. The reason is that the first bezel region 11 and the second bezel region 12 are disposed along the first direction y and the lead group 4 connected to the drive electrode 30 in the second bezel region 12 can directly lead the lead 40 out to the bonding pad 6. In some embodiments, the auxiliary lead group 5 may also be disposed between the lead group 4 connected to the drive electrode 30 in the second bezel region 12 and the bonding pad 6.

For example, referring to FIG. 7, along the first direction y, the first bezel region 11 is located below the liquid crystal prism, and the second bezel region 12 is located above the liquid crystal prism. The lead 40 is electrically connected only to a lower end of the drive electrode 30, that is, the lead 40 is electrically connected to the portion of the drive electrode 30 located in the first bezel region 11. The auxiliary lead group 5 is located in the first bezel region 11 and between the lead group 4 and the bonding pad 6.

For example, referring to FIG. 2, along the first direction y, the first bezel region 11 is located below the liquid crystal prism, and the second bezel region 12 is located above the liquid crystal prism. A lead group 4 is disposed to be electrically connected to an upper end of the drive electrode 30, and a lead group 4 is disposed to be electrically connected to a lower end of the drive electrode 30. The lead group 4 electrically connected to the upper end of the drive electrode 30 is directly led out to the bonding pad 6. The lead group 4 electrically connected to the lower end of the drive electrode 30 is led out to the bonding pad 6 via the auxiliary lead group 5.

It is to be understood that when the lead 40 is electrically connected to the portion of the drive electrode 30 located in the second bezel region 12, the portion of the drive electrode 30 located in the second bezel region 12 can be directly electrically connected to the bonding pad 6 via the lead 40 without the need for cross-wiring. When the lead 40 is electrically connected to the portion of the drive electrode 30 located in the first bezel region 11, since the bonding pad 6 is also in the first bezel region 11 and the electrical connection between the lead 40 and all the drive electrodes 30 needs to be ensured, a requirement for a flexible position of the bonding pad 6 and not increased resistance cannot be met. Therefore, in this case, the auxiliary lead group 5 needs to be disposed.

In the technical solution of the embodiment of the present disclosure, the second bezel region 12 is disposed, and the lead 40 may also be electrically connected to the portion of the drive electrode 30 located in the second bezel region 12 so that the lead 40 leads both ends of the drive electrode 30 out to the bonding pad 6. The auxiliary lead group 5 is also disposed between at least one lead group 4 and the region 61 where the bonding pad 6 is located to ensure the flexibility of the position where the bonding pad 6 is disposed.

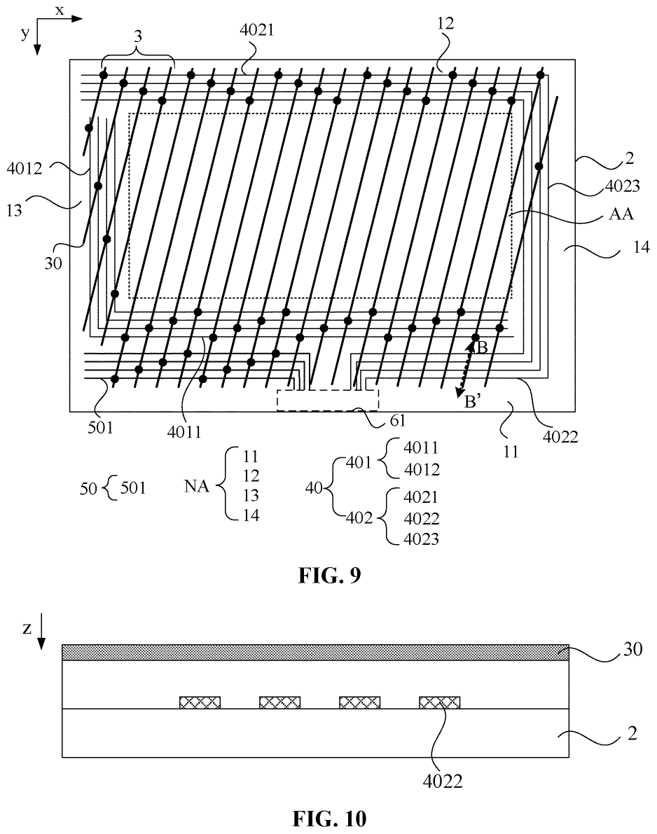

Optionally, FIG. 8 is a structural diagram of a third liquid crystal prism according to an embodiment of the present disclosure. As shown in FIG. 8, the auxiliary lead 50 includes a first line segment 501 located in the first bezel region 11, the lead 40 includes a first lead 401 electrically connected to the auxiliary lead 50, and the first lead 401 includes a second line segment 4011 located in the first bezel region 11; the number of drive electrodes 30 electrically connected to the first line segment 501 is less than the number of drive electrodes 30 electrically connected to the second line segment 4011.

The first line segment 501 can be used for being electrically connected to the lead 40 via the drive electrode 30. The first lead 401 may be a lead 40 connected to a lower end of the drive electrode 30, and the second line segment 4011 may be a lead 40 connected to the drive electrode 30 and located in the first bezel region 11.

Since the first lead 401 needs to be electrically connected to all the drive electrodes 30, the second line segment 4011 needs to be electrically connected to all drive electrodes 30 in the first bezel region 11 and the first line segment 501 only leads some leads 40 out to bonding pads 6, the number of drive electrodes 30 electrically connected to the first line segment 501 is set to be less than the number of drive electrodes 30 electrically connected to the second line segment 4011 so that an extension length of the first line segment 501 may be less than an extension length of the second line segment 4011, thereby making the position where the bonding pads 6 are disposed more flexible. The leads 40 in the lead group 4 need to be electrically connected to all the drive electrodes 30, while the auxiliary leads 50 in the auxiliary lead group 5 do not need to be electrically connected to all the drive electrodes 30 and only need to be connected to at least some leads 40. The auxiliary lead 50 provides or receives a signal for the lead 40. Therefore, a position where the auxiliary lead group 5 is disposed is more flexible relative to a position where the lead group 4 is disposed.

For example, the first line segment 501 and the second line segment 4011 extend along a second direction x, where the first direction y intersects the second direction x. The first bezel region 11 is located at a lower end of the liquid crystal prism. The first lead 401 connected to the lower end of the drive electrode 30 is disposed, and the first lead 401 is connected to all the drive electrodes 30. The first lead 401 includes the second line segment 4011 located in the first bezel region 11, and the second line segment 4011 is electrically connected to all the drive electrodes 30 in the first bezel region 11. The auxiliary lead 50 includes the first line segment 501 in the first bezel region 11, and an auxiliary lead 50 within the first line segment 501 is electrically connected to a lead 40 within the second line segment 4011 via some drive electrodes 30. The bonding pads 6 are disposed in the middle of the first bezel region 11, and in an x direction, a length of the first line segment 501 is less than a length of the second line segment 4011.

In some embodiments, an extension direction of the drive electrode 30 intersects the first direction y and intersects the second direction x. In an example, one side of the optical region AA extends along the second direction x, and the other side of the optical region AA extends along the first direction y. The extension direction of the drive electrode 30 is set to be inclined.

In the technical solution of the embodiment of the present disclosure, the auxiliary lead 50 includes the first line segment 501 located in the first bezel region 11, the lead 40 includes the first lead 401, the first lead 401 includes a second line segment 4011 located in the first bezel region 11, and the number of drive electrodes 30 electrically connected to the first line segment 501 is less than the number of drive electrodes 30 electrically connected to the second line segment 4011, so that the length of the first line segment 501 can be smaller than the length of the second line segment 4011, and the length of the first line segment 501 can be flexibly set according to the position of the bonding pad 6.

Optionally, with continued reference to FIG. 8, the lead 40 further includes a second lead 402 electrically insulated from the first lead 401 and including a third line segment 4021 located in the second bezel region 12, and the number of drive electrodes 30 electrically connected to the first line segment 501 is less than the number of drive electrodes 30 electrically connected to the third line segment 4021; the second lead 402 includes a fourth line segment 4022 located in the first bezel region 11, the third line segment 4021 is electrically connected to a bonding pad 6 via the fourth line segment 4022, and along the first direction y, the fourth line segment 4022 is located between the second line segment 4011 and the region where the bonding pad 6 is located.

The second lead 402 can be used for being electrically connected to the upper end of the drive electrode 30. The lead 40 connected to the upper end of the drive electrode 30 is electrically insulated from the lead 40 connected to the lower end of the drive electrode 30 so that the leads 40 lead two ends of the drive electrode 30 out to bonding pads 6, respectively. The second lead 402 includes the third line segment 4021 located in the second bezel region 12, and the third line segment 4021 is connected to all drive electrodes 30 in the second bezel region 12. Since the first line segment 501 is electrically connected to the second line segment 4011 via only some drive electrodes 30, the number of drive electrodes 30 electrically connected to the first line segment 501 is less than the number of drive electrodes 30 electrically connected to the third line segment 4021.

The second lead 402 further includes the fourth line segment 4022 located in the first bezel region 11, and the fourth line segment 4022 can be used for being electrically connected to the bonding pad 6. Therefore, the third line segment 4021 is electrically connected to the bonding pad 6 via the fourth line segment 4022. To reduce wires and reduce resistance, along the first direction y, the fourth line segment 4022 is disposed between the second line segment 4011 and the region 61 where the bonding pad 6 is located.

Specifically, the liquid crystal prism includes the second lead 402 connected to the upper end of the drive electrode 30 and the first lead 401 connected to the lower end of the drive electrode 30. The first lead 401 includes the second line segment 4011 extending along the second direction x and located in the first bezel region 11, and the second lead 402 includes the third line segment 4021 extending along the second direction x and located in the second bezel region 12. The second line segment 4011 is connected to all the drive electrodes 30 in the first bezel region 11, and the third line segment 4021 is connected to all the drive electrodes 30 in the second bezel region 12. The second lead 402 further includes the fourth line segment 4022 located in the first bezel region 11, and the fourth line segment 4022 also extends along the second direction x. The second line segment 4011 is electrically connected to the bonding pad 6 via the first line segment 501, and the third line segment 4021 is electrically connected to the bonding pad 6 via the fourth line segment 4022.

For example, when the first lead 401 and the second lead 402 are led out to the bonding pads 6, respectively, an open-circuit detection of the drive electrode 30 can be performed. Specifically, the first lead 401 may be used as a signal input terminal, and the second lead 402 may be used as a signal receiving terminal. The flexible printed circuit is bonded to the bonding pads 6 and inputs open-circuit detection signals to signal input terminals of first leads 401, and the open-circuit detection signals enter all the drive electrodes 30 from the first leads 401, respectively. The flexible printed circuit receives the open-circuit detection signals from signal receiving terminals. When the flexible printed circuit can receive an open-circuit detection signal of a corresponding drive electrode 30, it indicates that no open circuit has occurred. When the flexible circuit board does not receive an open-circuit detection signal of a corresponding drive electrode 30, it indicates that an open circuit has occurred at the drive electrode 30.

For example, when the first lead 401 and the second lead 402 are led out to the bonding pads 6, respectively, a short-circuit detection of the drive electrode 30 can also be performed. Specifically, the first lead 401 may be used as a signal input terminal, and the second lead 402 may be used as a signal receiving terminal. The flexible printed circuit is bonded to the bonding pads 6 and inputs short-circuit detection signals to signal input terminals of different first leads 401, respectively, and the short-circuit detection signals enter all the drive electrodes 30 from the first leads 401, respectively. When the flexible printed circuit receives different short-circuit detection signals from different signal receiving terminals, respectively, it indicates that no short circuit has occurred. When the flexible printed circuit receives the same short-circuit detection signal from different signal receiving terminals, it indicates that a short circuit has occurred at the drive electrode 30.

It is to be understood that only when the first lead 401 is electrically connected to all the drive electrodes 30 and the second lead 402 is electrically connected to all the drive electrodes 30 can the open-circuit and short-circuit detections of all the drive electrodes 30 be achieved.

In the technical solution of the embodiment of the present disclosure, the second lead 402 is disposed, the second lead 402 is disconnected from the first lead 401 and electrically connected to the bonding pad 6, and the first lead 401 is electrically connected to the bonding pad 6 via the auxiliary lead 50. In this manner, the bonding pads 6 can be disposed flexibly, and the open-circuit and short-circuit detections of the drive electrodes 30 in the liquid crystal prism can be achieved.

Optionally, with continued reference to FIG. 8, the non-optical region NA further includes a third bezel region 13 and a fourth bezel region 14, the third bezel region 13 and the fourth bezel region 14 are located on two opposite sides of the optical region AA, and the third bezel region 13 is connected to the first bezel region 11 and the second bezel region 12; the first lead 401 further includes a fifth line segment 4012 located in the third bezel region 13 and electrically connected to the second line segment 4011, and the second lead 402 further includes a sixth line segment 4023 located in the fourth bezel region 14 and electrically connected to the third line segment 4021 and the fourth line segment 4022.

The first bezel region 11, the second bezel region 12, the third bezel region 13 and the fourth bezel region 14 are disposed around the optical region AA to constitute the non-optical region NA. The third bezel region 13 and the fourth bezel region 14 are located on two sides of the optical region AA and connected to the first bezel region 11 and the second bezel region 12. The fourth bezel region 14 is also connected to the first bezel region 11 and the second bezel region 12.

To ensure that the first lead 401 is connected to all the drive electrodes 30, the first lead 401 further includes the fifth line segment 4012 located in the third bezel region 13. To ensure that the second lead 402 is connected to all the drive electrodes 30, the second lead 402 further includes the sixth line segment 4023 located in the fourth bezel region 14.

For example, the extension direction of the drive electrode 30 intersects the first direction y and the second direction x. The drive electrodes 30 are located in the optical region AA, the first bezel region 11, the second bezel region 12, the third bezel region 13 and the fourth bezel region 14. The first lead 401 is located in the third bezel region 13 and the first bezel region 11. The fifth line segment 4012 of the first lead 401 is electrically connected to lower ends of all drive electrodes 30 located in the third bezel region 13, and the second line segment 4011 of the first lead 401 is electrically connected to lower ends of all the drive electrodes 30 located in the first bezel region 11. The second lead 402 is located in the second bezel region 12 and the fourth bezel region 14. The third line segment 4021 of the second lead 402 is electrically connected to upper ends of all the drive electrodes 30 located in the second bezel region 12, and the sixth line segment 4023 of the second lead 402 is electrically connected to upper ends of all drive electrodes 30 located in the fourth bezel region 14.

In the technical solution of the embodiment of the present disclosure, the fifth line segment 4012 is disposed in the first lead 401, and the sixth line segment 4023 is disposed in the second lead, thereby ensuring that both the first lead 401 and the second lead 402 are electrically connected to all the drive electrodes 30.

Optionally, FIG. 9 is a structural diagram of a fourth liquid crystal prism according to an embodiment of the present disclosure, and FIG. 10 is a sectional view taken along BB′ in FIG. 9. In conjunction with FIGS. 9 and 10, in a direction perpendicular to the substrate 2, the fourth line segment 4022 overlaps the drive electrode 30.

Since the auxiliary lead 50 is electrically connected to the first lead 401 via some drive electrodes 30, in the direction perpendicular to the substrate 2, some electrodes 30 overlap the second lead 402, the first lead 401 and the auxiliary lead 50. To ensure, as far as possible, that the number of crossing lines of the drive electrode 30 is the same and an overlap capacitance between the drive electrode 30 and a metal line is consistent, in the direction perpendicular to the substrate 2, the fourth line segment 4022 also overlaps the drive electrode 30.

For example, in conjunction with FIGS. 5, 9 and 10, the extension direction of the drive electrode 30 is set to intersect the first direction y and the second direction x. In the direction perpendicular to the substrate 2, the drive electrode 30 connected to the auxiliary lead 50 separately overlaps the first lead 401, the second lead 402 and the auxiliary lead 50. The fourth line segment 4022 connected to the bonding pad 6 also overlaps the drive electrode 30 so that the drive electrode 30 connected to the auxiliary lead 50 and the drive electrode 30 overlapping the fourth line segment 4022 have the same number of crossing lines and a consistent overlap capacitance.

In the technical solution of the embodiment of the present disclosure, in the direction perpendicular to the substrate, the fourth line segment 4022 overlaps the drive electrode 30 so that the number of crossing lines is the same for as many drive electrodes 30 as possible in the liquid crystal prism and the overlap capacitance between the drive electrode 30 and the metal line is consistent.

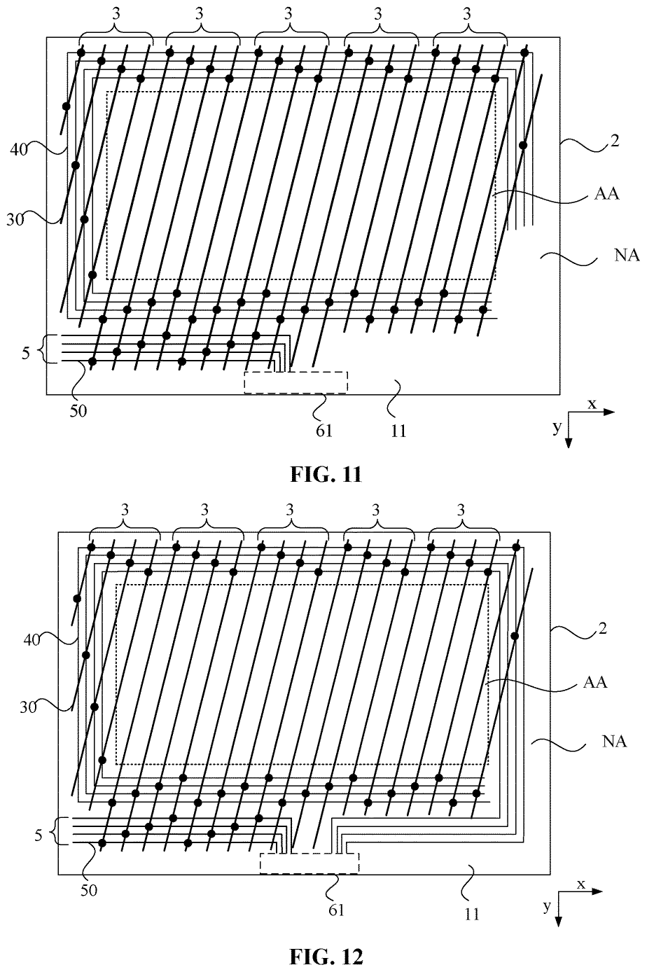

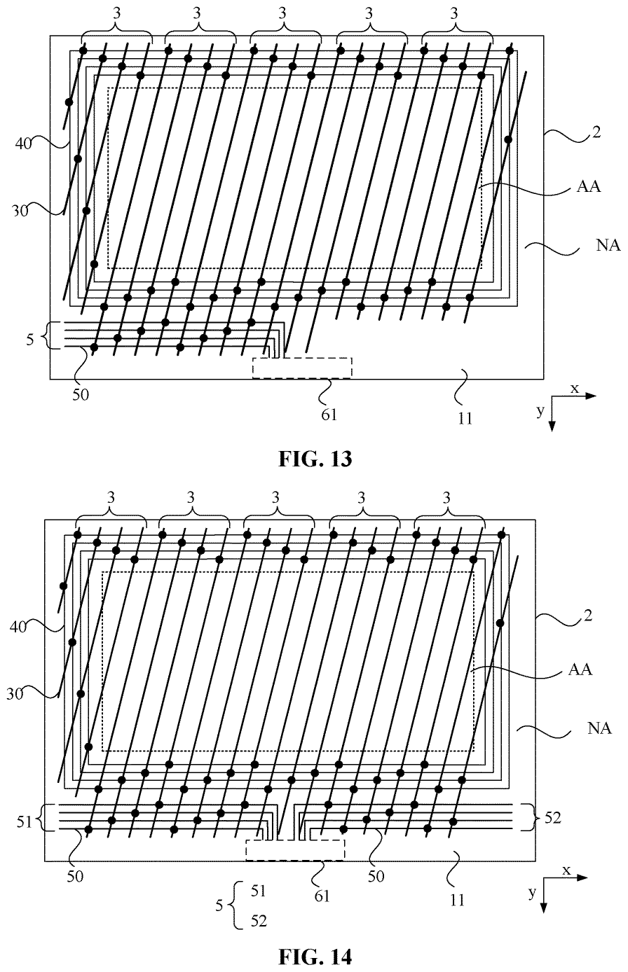

Optionally, FIG. 11 is a structural diagram of a fifth liquid crystal prism according to an embodiment of the present disclosure, FIG. 12 is a structural diagram of a sixth liquid crystal prism according to an embodiment of the present disclosure, and FIG. 13 is a structural diagram of a seventh liquid crystal prism according to an embodiment of the present disclosure. As shown in FIGS. 11, 12 and 13, the same lead 40 is electrically connected to two opposite ends of a drive electrode 30.

The same lead 40 can also be connected to both ends of the drive electrode 30. In this manner, the bonding pad 6 can also receive a signal from the drive electrode 30 or output a signal to the drive electrode 30. When the same lead 40 is electrically connected to two opposite ends of the drive electrode 30, the auxiliary lead 50 located in the first bezel region 11 is electrically connected only to the lead 40 in the first bezel region 11.

For example, as shown in FIG. 11, the same lead 40 forms a non-closed shape disposed around the optical region AA and is separately electrically connected to two ends of the drive electrode 30, and the auxiliary lead 50 is disposed in the first bezel region 11, thereby achieving the electrical connection between the lead 40 and the bonding pad 6.

For example, as shown in FIG. 12, the same lead 40 forms a non-closed shape disposed around the optical region AA, one end of the lead 40 is connected to the bonding pad 6, both ends of the drive electrode 30 are electrically connected to the lead 40, and the auxiliary lead 50 is disposed in the first bezel region 11, thereby achieving the electrical connection between the lead 40 and the bonding pad 6.

In some embodiments, as shown in FIG. 13, to ensure that leads 40 connected to drive electrodes 30 in the optical region AA are uniformly distributed, the same lead 40 is disposed to form a closed shape surrounding the optical region AA. For example, the optical region AA may have a rectangular structure, the drive electrode 30 extends through the optical region AA, the lead group 4 is disposed around the optical region AA and separately electrically connected to all the drive electrodes 30, and the same lead 40 is electrically connected to two opposite ends of the drive electrode 30. The auxiliary lead 50 is disposed in the first bezel region 11, thereby achieving the electrical connection between the lead 40 and the bonding pad 6.

In the technical solution of the embodiment of the present disclosure, the same lead 40 is electrically connected to two opposite ends of the drive electrode 30 so that the bonding pad 6 can also receive a signal from the drive electrode 30 or output a signal to the drive electrode 30. When the same lead 40 is electrically connected two opposite ends of the drive electrode 30 to form a closed shape, it helps to improve the electrical uniformity of the lead 40 at various positions.

Optionally, FIG. 14 is a structural diagram of an eighth liquid crystal prism according to an embodiment of the present disclosure. As shown in FIG. 14, the auxiliary lead group 5 includes a first auxiliary lead group 51 and a second auxiliary lead group 52; along a second direction x, the first auxiliary lead group 51 is spaced apart from the second auxiliary lead group 52.

To ensure, as far as possible, that the number of crossing lines of the drive electrode 30 is the same and an overlap capacitance between the drive electrode 30 and a metal line is consistent, the auxiliary lead group 5 includes the first auxiliary lead group 51 and the second auxiliary lead group 52, and the first auxiliary lead group 51 is spaced apart from the second auxiliary lead group 52 so that some drive electrodes 30 overlap the lead 40 and the first auxiliary lead group 51 and some drive electrodes 30 overlap the lead 40 and the second auxiliary lead group 52.

Specifically, the lead group 4 forms a closed shape surrounding the optical region AA, and each lead 40 in the lead group 4 is connected to two ends of a drive electrode 30. The first auxiliary lead group 51 is spaced apart from the second auxiliary lead group 52 in the first bezel region 11, and each of the first auxiliary lead group 51 and the second auxiliary lead group 52 is electrically connected to the lead 40 via some drive electrodes 30.

In the technical solution of the embodiment of the present disclosure, the first auxiliary lead group 51 and the second auxiliary lead group 52 are disposed to ensure, as far as possible, that the number of crossing lines of the drive electrode 30 is the same and the overlap capacitance between the drive electrode 30 and the metal line is consistent, thereby improving the electrical performance of the liquid crystal prism.

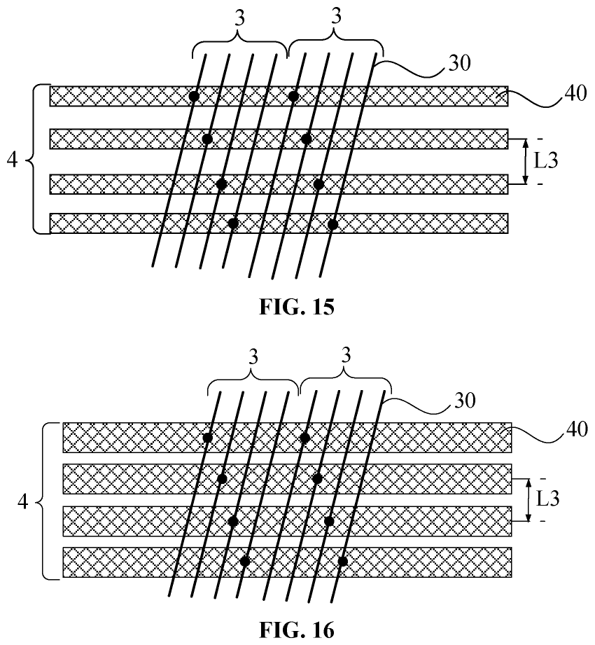

Optionally, FIG. 15 is a first enlarged view of the position B in FIG. 2, and FIG. 16 is a second enlarged view of the position B in FIG. 2. In conjunction with FIGS. 4, 15 and 16, spacing L1 between adjacent leads 40 in the first bezel region 11 is less than spacing L3 between adjacent leads 40 in the second bezel region 12, and/or spacing L2 between adjacent auxiliary leads 50 in the first bezel region 11 is less than spacing L3 between adjacent leads 40 in the second bezel region 12.

Spacing between leads 40 refers to a vertical distance between a center of one lead 40 and a center of the other lead 40, and spacing between auxiliary leads 50 refers to a vertical distance between a center of one auxiliary lead 50 and a center of the other auxiliary lead 50. Spacing between adjacent leads 40 may be a distance between centers of adjacent leads 40 along a line width direction, and spacing between adjacent auxiliary leads 50 may be a distance between centers of adjacent auxiliary leads 50 along a line width direction.

Since the auxiliary lead group 5 is added in the first bezel region 11 in the embodiment of the present disclosure, to avoid increasing a width of the first bezel region 11, the spacing L1 between adjacent leads 40 in the first bezel region 11 and/or the spacing L2 between adjacent auxiliary leads 50 in the first bezel region 11 can be reduced.

Specifically, in conjunction with FIGS. 4 and 15, reducing the spacing L1 between adjacent leads 40 in the first bezel region 11 and/or reducing the spacing L2 between adjacent auxiliary leads 50 in the first bezel region 11 may be reducing a line width of the lead 40 and/or a line width of the auxiliary lead 50. In conjunction with FIGS. 4 and 16, reducing the spacing L1 between adjacent leads 40 in the first bezel region 11 and/or reducing the spacing L2 between adjacent auxiliary leads 50 in the first bezel region 11 may also be reducing minimum spacing between adjacent leads 40 and/or minimum spacing between adjacent auxiliary leads 50.

For example, FIG. 4 illustrates a liquid crystal prism obtained after the line width of the lead 40 and the line width of the auxiliary lead 50 are reduced. In conjunction with FIGS. 4 and 15, the line width of the lead 40 is reduced so that the spacing L1 between adjacent leads 40 in the first bezel region 11 is less than the spacing L3 between adjacent leads 40 in the second bezel region 12, and the line width of the auxiliary lead 50 is reduced so that the spacing L2 between adjacent auxiliary leads 50 in the first bezel region 11 is less than the spacing L3 between adjacent leads 40 in the second bezel region 12.

For example, FIG. 4 illustrates a liquid crystal prism obtained after the minimum spacing between adjacent leads 40 and the minimum spacing between adjacent auxiliary leads 50 are reduced. In conjunction with FIGS. 4 and 16, the minimum spacing between adjacent leads 40 is reduced so that the spacing L1 between adjacent leads 40 in the first bezel region 11 is less than the spacing L3 between adjacent leads 40 in the second bezel region 12, and the line width of the auxiliary lead 50 is reduced so that the spacing L2 between adjacent auxiliary leads 50 in the first bezel region 11 is less than the spacing L3 between adjacent leads 40 in the second bezel region 12.

In some embodiments, with continued reference to FIG. 4, the spacing L1 between the adjacent leads 40 in the first bezel region 11 is equal to the spacing L2 between the adjacent auxiliary leads 50 in the first bezel region 11 so that the metal line spacing in the first bezel region 11 is reduced through a process and the width of the first bezel region 11 is further reduced.

In the technical solution of the embodiment of the present disclosure, the spacing between adjacent leads 40 in the first bezel region 11 is set to be less than the spacing between adjacent leads 40 in the second bezel region 12, and/or the spacing between adjacent auxiliary leads 50 in the first bezel region 11 is set to be less than the spacing between adjacent leads 40 in the second bezel region 12, thereby reducing the space occupied by the lead 40 and/or the auxiliary lead 50 in the first bezel region 11 and solving the problem that the first bezel region 11 is widened since the auxiliary lead group 5 is disposed.

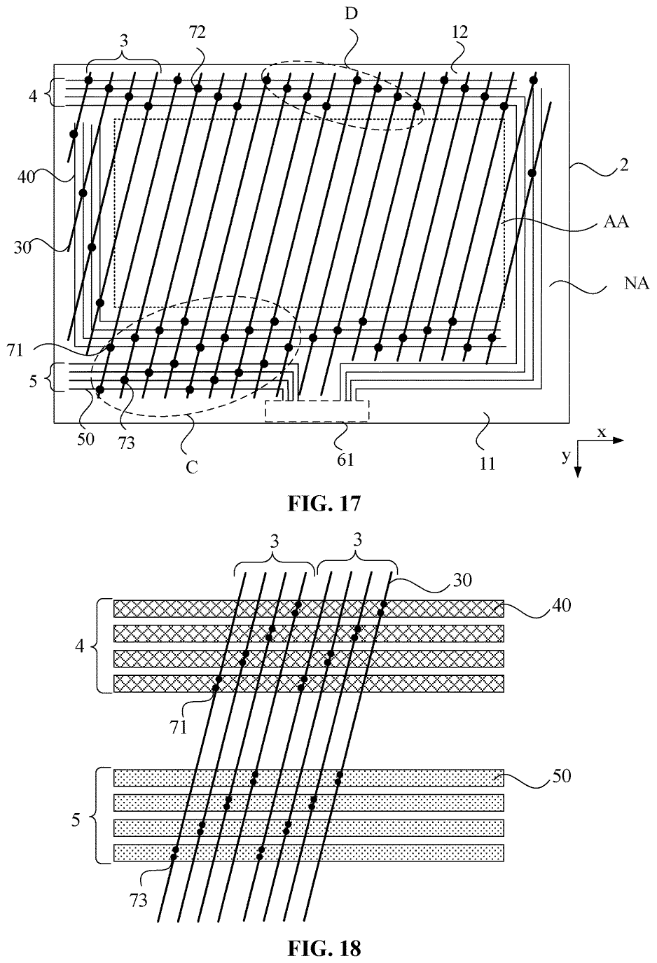

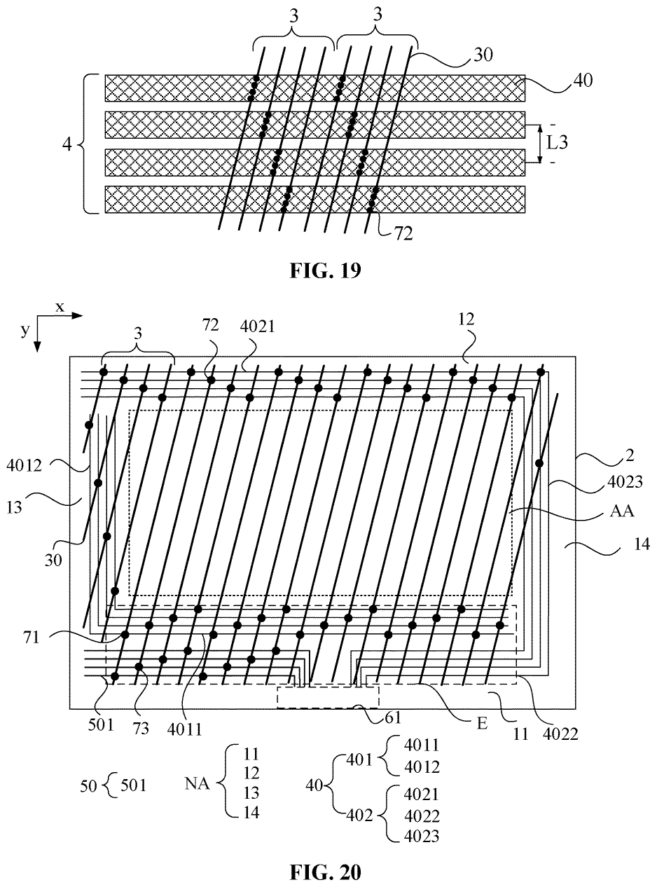

Optionally, FIG. 17 is a structural diagram of a ninth liquid crystal prism according to an embodiment of the present disclosure, FIG. 18 is an enlarged view of the position C in FIG. 17, and FIG. 19 is an enlarged view of the position D in FIG. 17. In conjunction with FIGS. 17, 18 and 19, the drive electrode 30 is electrically connected to the lead 40 via a first via 71 in the first bezel region 11, the drive electrode 30 is electrically connected to the lead 40 via a second via 72 in the second bezel region 12, and the drive electrode 30 is electrically connected to the auxiliary lead 50 via a third via 73 in the first bezel region 11; the number of first vias 71 connected to the same drive electrode 30 is less than the number of second vias 72 connected to the same drive electrode 30, and/or the number of third vias 73 connected to the same drive electrode 30 is less than the number of second vias 72 connected to the same drive electrode 30.

Since the drive electrode 30, the lead 40 and the auxiliary lead 50 are not disposed in the same layer, the drive electrode 30 needs to be electrically connected to the lead 40 and the auxiliary lead 50 via vias. Providing the lead 40 and the auxiliary lead 50 with the vias needs space. When the line widths of the lead 40 and the auxiliary lead 50 are reduced to a certain extent, the number of vias is reduced. Therefore, when the line width of the lead 40 and/or the auxiliary lead 50 is reduced, the number of first vias 71 connected to the same drive electrode 30 is less than the number of second vias 72 connected to the same drive electrode 30, and/or the number of third vias 73 connected to the same drive electrode 30 is less than the number of second vias 72 connected to the same drive electrode 30.

For example, in conjunction with FIGS. 17, 18 and 19, when the line widths of both the lead 40 and the auxiliary lead 50 are reduced, the space for providing the vias is reduced. As a result, only two first vias 71 can be provided at a connection position of the drive electrode 30 and the lead 40 in the first bezel region 11, and only two third vias 73 can be provided at a connection position of the drive electrode 30 and the auxiliary lead 50 in the first bezel region. Since the line widths in the second bezel region 12 are unchanged, four second vias 72 may be provided at a connection position of the drive electrode 30 and the lead 40 in the second bezel region 12. In this case, the number of first vias 71 connected to the same drive electrode 30 is less than the number of second vias 72 connected to the same drive electrode 30. It is to be understood that the reason why as many vias as possible are provided at the connection position of the metal line is to avoid the fact that the electrical connection between the drive electrode 30 and the metal line cannot be achieved due to a certain via.

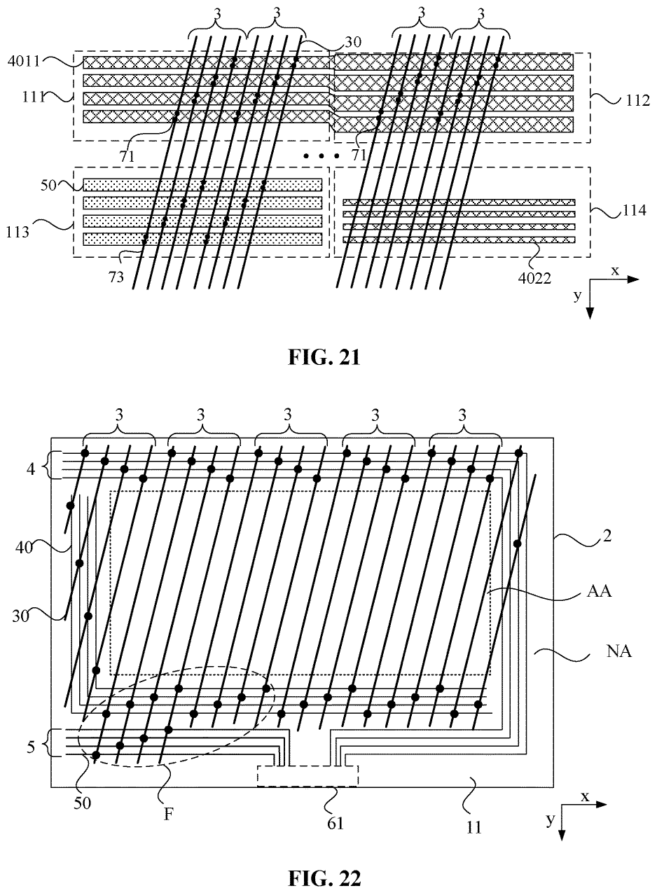

In some embodiments, FIG. 20 is a structural diagram of a tenth liquid crystal prism according to an embodiment of the present disclosure, and FIG. 21 is an enlarged view of the position E in FIG. 20. In conjunction with FIGS. 20 and 21, the non-optical region NA includes a first lead 401 and a second lead 402. The second lead 402 includes a third line segment 4021 located in the second bezel region 12 and a fourth line segment 4022 located in the first bezel region 11. The first lead 401 includes a second line segment 4011 located in the first bezel region 11. The drive electrode 30 is electrically connected to the third line segment 4021 via a second via 72, the drive electrode 30 is electrically connected to the second line segment 4011 via a first via 71, and the drive electrode 30 is electrically connected to the auxiliary lead 50 via a third via 73 in the first bezel region 11. Along a direction perpendicular to the substrate 2, the fourth line segment 4022 overlaps but is not electrically connected to the drive electrode 30. Therefore, a line width of a lead 40 within the fourth line segment 4022 can be reduced, and the line width of the lead 40 within the fourth line segment 4022 is greater than a line width of the third line segment 4021. Further, the first bezel region 11 includes a first region 111, a second region 112, a third region 113 and a fourth region 114. A width of the first bezel region 11 is determined by dimensions of the first region 111 and the third region 113 in a first direction y and dimensions of the second region 112 and the fourth region 114 in the first direction y. A second line segment 4011 extending along the first direction y is disposed in the first region 111 and the second region 112, an auxiliary lead 50 extending along the first direction y is disposed in the third region 113, and a fourth line segment 4022 extending along the first direction y is disposed in the fourth region 114. A line width of the second line segment 4011 in the second region 112 is greater than a line width of the second line segment 4011 in the first region 111, the line width of the second line segment 4011 in the first region 111 is equal to a line width of the auxiliary lead 50 in the third region 113, and the line width of the second line segment 4011 in the first region 111 is greater than a line width of the fourth line segment 4022 in the fourth region 114. In this manner, the problem of an increased width of the first bezel region 11 is solved, and the bezels surrounding the optical region AA are more balanced, which is beneficial to the preparation in process.

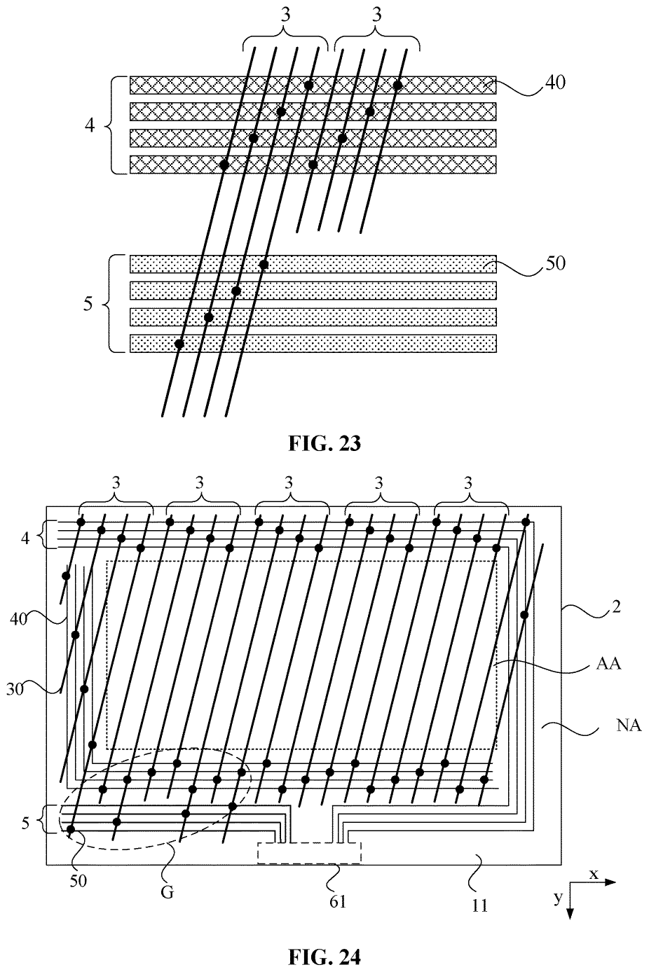

Optionally, FIG. 22 is a structural diagram of an eleventh liquid crystal prism according to an embodiment of the present disclosure, and FIG. 23 is an enlarged view of the position F in FIG. 22. In conjunction with FIGS. 22 and 23, one auxiliary lead 50 is electrically connected to one drive electrode 30.

Since the lead 40 needs to be electrically connected to all the drive electrodes 30, setting one auxiliary lead 50 to be electrically connected to one drive electrode 30 can achieve the electrical connection between the auxiliary lead 50 and the lead 40.

For example, each electrode group 3 includes four different drive electrodes 30, the lead group 4 includes four different leads 40 electrically connected to the four different drive electrodes 30, respectively, the auxiliary lead group 5 includes four auxiliary leads 50, and each auxiliary lead 50 is electrically connected to one drive electrode 30, thereby achieving an electrical connection to a corresponding lead 40. Since the same drive electrode 30 in different electrode groups 3 is disposed in parallel, setting one auxiliary lead 50 to be electrically connected to one drive electrode 30 can achieve signal reception and input of all leads 40.

In the technical solution of the embodiment of the present disclosure, setting one auxiliary lead 50 to be electrically connected to one drive electrode 30 ensures the signal reception and input of the leads 40, simplifies the preparation process and improves the preparation efficiency.

Optionally, FIG. 24 is a structural diagram of a twelfth liquid crystal prism according to an embodiment of the present disclosure. In conjunction with FIGS. 22, 23, 24 and 25, multiple drive electrodes 30 electrically connected to auxiliary leads 50 in the same auxiliary lead group 5 are located in one or more electrode groups 3.

Multiple drive electrodes 30 electrically connected to auxiliary leads 50 in the same auxiliary lead group 5 may be located in one electrode group 3 or multiple electrode groups 3, which can ensure the connection to all the leads 40.

For example, as shown in FIGS. 22 and 23, each electrode group 3 includes four different drive electrodes 30, the lead group 4 includes four different leads 40, the leads 40 are electrically connected to four different drive electrodes 30 in the same electrode group 3, respectively, and the same drive electrode 30 in a different electrode group 3 is disposed in parallel. The auxiliary lead group 5 includes four auxiliary leads 50, and the auxiliary leads 50 are connected to the drive electrodes 30, respectively, thereby achieving the electrical connection to all the leads 40.

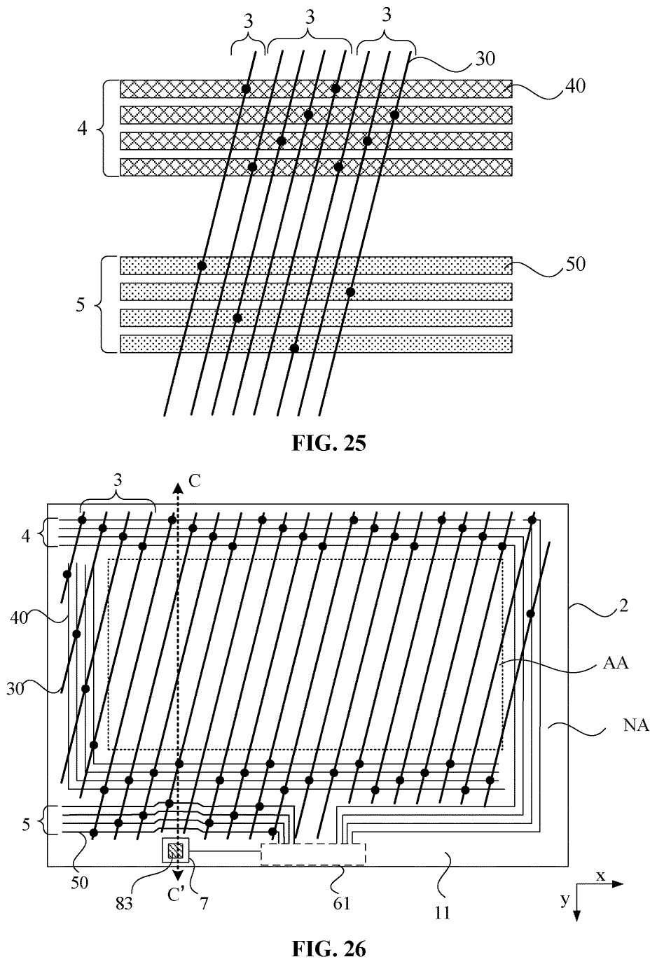

For example, as shown in FIGS. 24 and 25, each electrode group 3 includes four different drive electrodes 30, the lead group 4 includes four different leads 40, the leads 40 are electrically connected to four different drive electrodes 30, respectively, and the same drive electrode 30 in a different electrode group 3 is disposed in parallel. The auxiliary lead group 5 includes four auxiliary leads 50, and the auxiliary leads 50 are connected to drive electrodes 30 in different electrode groups 3, respectively, thereby achieving the electrical connection to all the leads 40.

In the technical solution of the embodiment of the present disclosure, multiple drive electrodes 30 electrically connected to auxiliary leads 50 in the same auxiliary lead group 5 are disposed in one or more electrode groups 3 so that the normal working of the liquid crystal prism is ensured and the liquid crystal prism is disposed more flexibly.

Optionally, with continued reference to FIGS. 2 and 4, one auxiliary lead 50 is electrically connected to at least two drive electrodes 30.

Since the resistance of the drive electrode 30 is high, to reduce the resistance, one auxiliary lead 50 is set to be electrically connected to at least two drive electrodes 30 so that two drive electrodes 30 connected to the same auxiliary lead 50 are connected in parallel.

For example, each electrode group 3 includes four different drive electrodes 30, the lead group 4 includes four different leads 40, the leads 40 are electrically connected to four different drive electrodes 30, respectively, and the same drive electrode 30 in a different electrode group 3 is disposed in parallel. The auxiliary lead group 5 includes four auxiliary leads 50, each auxiliary lead 50 is connected to all drive electrodes 30 in one electrode group 3 and also connected to all drive electrodes 30 in another electrode group 3.

In the technical solution of the embodiment of the present disclosure, one auxiliary lead 50 is set to be electrically connected to at least two drive electrodes 30 so that two drive electrodes 30 connected to the same auxiliary lead 50 are connected in parallel, thereby reducing the resistance. The problem that a signal cannot be transmitted when a single auxiliary lead 50 is in wire breakage with the drive electrode 30 can be avoided, and an increase in redundancy of the electrical connection can be avoided.

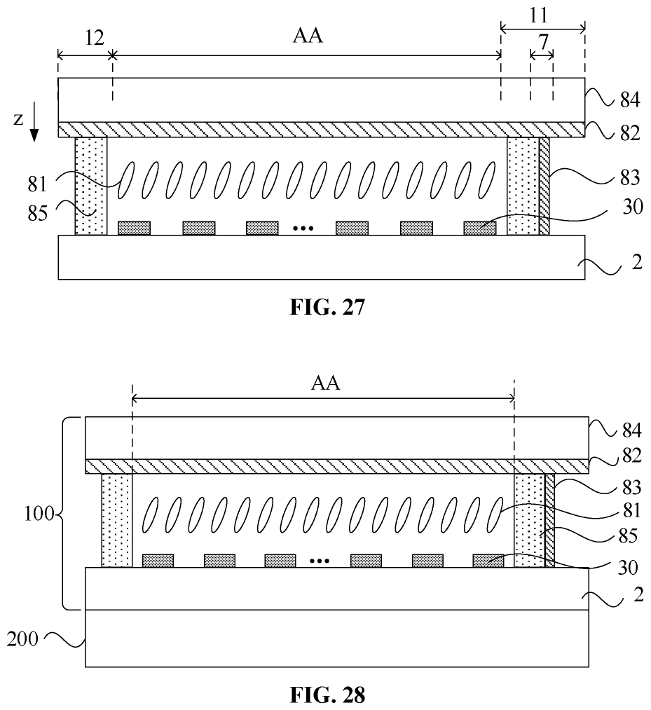

Optionally, FIG. 26 is a structural diagram of a thirteenth liquid crystal prism according to an embodiment of the present disclosure, and FIG. 27 is a sectional view taken along CC′ in FIG. 26. The number of drive electrodes 30 is relatively small in the top view shown in FIG. 27 due to limited space. In fact, more than three drive electrodes 30 may be included in the sectional structure taken along AA′ in FIG. 27. In conjunction with FIGS. 26 and 27, the first bezel region 11 further includes an avoidance region 7, and along a direction perpendicular to the substrate 2, none of the drive electrodes 30, the leads 40 and the auxiliary leads 50 overlap the avoidance region 7; the drive electrodes 30, the leads 40 and the auxiliary leads 50 are disposed outside the avoidance region 7. The liquid crystal prism further includes a liquid crystal layer 81, a common electrode 82 and a connector 83, the liquid crystal layer 81 includes multiple liquid crystal molecules, and the liquid crystal layer 81 is located between the drive electrodes 30 and the common electrode 82. One end of the connector 83 is connected to the common electrode 82, and the other end of the connector 83 is located in the avoidance region 7.

The liquid crystal layer 81 may include multiple liquid crystal molecules, and a change in optical path is controlled by controlling the deflection angle of the liquid crystal molecules in the liquid crystal prism. The common electrode 82 may serve as a reference electrode for the voltage for forming a stable potential difference with the drive electrode 30. The connector 83 can be used to lead the common electrode 82 disposed on an opposing substrate 84 of the liquid crystal prism out to the substrate 2. The common electrode 82 is electrically connected to the bonding pad 6 disposed on the substrate 2 and can be connected to an external control circuit via a flexible printed circuit bonded to and electrically connected to the bonding pad 6. To prevent a short circuit between the connector 83 and at least one of the drive electrode 30, the lead 40 or the auxiliary lead 50, the avoidance region 7 is disposed, and the connector 83 is disposed in the avoidance region 7.

For example, the drive electrode 30 is disposed on one side of the substrate 2, the liquid crystal layer 81 is located on the side of the drive electrode 30 facing away from the substrate 2, and the common electrode 82 is located on a side of the liquid crystal layer 81 facing away from the drive electrode 30. The liquid crystal prism is also provided with a sealant 85, and the sealant 85, the substrate 2 and the opposing substrate 84 form a closed space where the liquid crystal layer 81 is accommodated.

For example, the liquid crystal prism 100 may include multiple prism units (not shown in the figure). Each prism unit includes an electrode group 3, and the prism units are in one-to-one correspondence with the electrode groups 3, that is, a region corresponding to one electrode group 3 constitutes one prism unit. The prism unit further includes liquid crystal molecules in the region corresponding to the electrode group 3 and a portion of the common electrode 82. In 3D display, the optical function of a prism unit is equivalent to that of a physical cylindrical lens.

Based on the same inventive concept, FIG. 28 is a structural diagram of a display device according to an embodiment of the present disclosure. As shown in FIG. 28, the embodiment of the present disclosure further provides a display device including a display panel 200 and a liquid crystal prism 100. The liquid crystal prism 100 is located on a light-emitting display side of the display panel 200. Specifically, when 3D display is performed, a voltage is applied to a drive electrode 30 in the liquid crystal prism 100, and liquid crystal molecules in each prism unit are controlled to perform deflection so that all prism units form a lenticular lens array, and the light emitted by the display panel 200 passes through the liquid crystal prism 100 to form a left eye image and a right eye image, and the left and right eye of the viewer receive images with parallax, respectively, and the images with parallax are synthesized into a 3D image in the brain of the viewer. When 2D display is performed, the same voltage as that of the common electrode 82 is applied to the drive electrode 30 in the liquid crystal prism 100, and when the voltage of the common electrode 82 is 0 V, a voltage may not need to be applied to the drive electrode 30 in the liquid crystal prism 100. Liquid crystal molecules in the liquid crystal prism 100 are arranged in parallel, and the light output from the display panel 200 is not subjected to optical splitting so that 2D display is performed after the light reaches human eyes.

In the technical solution of the embodiment of the present disclosure, the display device includes the display panel 200 and the liquid crystal prism 100, and a position of a bonding pad 6 of the liquid crystal prism is disposed flexibly, thereby reducing a bonding risk during a subsequent connection between the bonding pad 6 and a flexible printed circuit in a hot pressing manner, achieving 2D display and 3D display and improving the reliability of the display device.

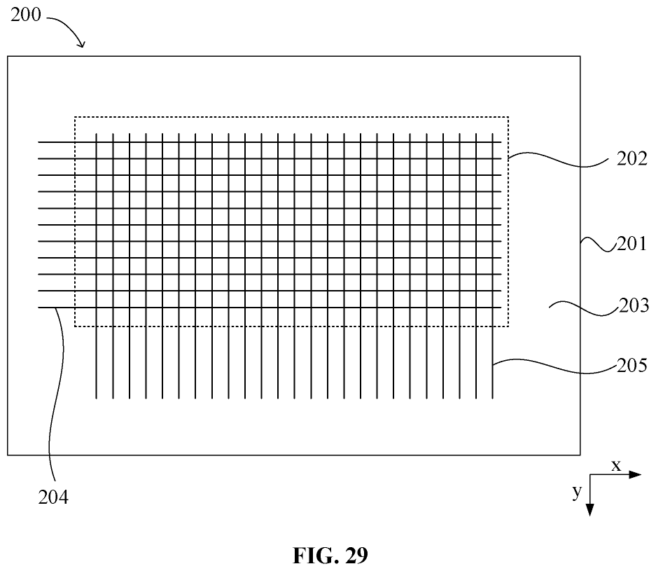

FIG. 29 is a structural diagram of a display panel according to an embodiment of the present disclosure. As shown in FIGS. 28 and 29, the display panel 200 includes a lower substrate 201, multiple scan lines 204 and multiple data lines 205, and the multiple scan lines 204 and the multiple data lines 205 are located on the same side of the lower substrate 201. The multiple scan lines 204 extend along a second direction x and are arranged along a first direction y. The multiple data lines 205 extend along the first direction y and are arranged along the second direction x. A sub-pixel electrically connected to the scan line 204 and the data line 205 is not shown in FIG. 29. A driver circuit providing signals to the scan line 204 and the data line 205 is also not shown in FIG. 29.

For example, the display panel 200 includes a display region 202 and a non-display region 203. The display region 202 corresponds to an optical region AA, and the non-display region 203 corresponds to a non-optical region NA. In an example, the liquid crystal prism 100 is stacked on a light-emitting display side of the display panel 200, the display region 202 faces the optical region AA and has the same area as that of the display region 202, or the optical region AA has a similar area as that of the display region 202 with the non-display region 203 facing the non-optical region NA. In addition, it is to be noted that to illustrate wires and connection relationships between the wires in the top view of the liquid crystal prism 100, the size of the non-optical region NA relative to that of the optical region AA is enlarged, and the actual size ratio of the non-optical region NA to the optical region AA is based on the actual product. Similarly, the actual size ratio of the display region 202 to the non-display region 203 is based on the actual product.

The preceding embodiments do not limit the scope of the present disclosure. It is to be understood by those skilled in the art that various modifications, combinations, sub-combinations, and substitutions may be made according to design requirements and other factors. Any modification, equivalent substitution, improvement, or the like that is made within the spirit and principle of the present disclosure is within the scope of the present disclosure.

What is claimed is:

1. A liquid crystal prism, comprising an optical region and a non-optical region located at a periphery of the optical region, wherein the non-optical region comprises a first bezel region located on one side of the optical region, and bonding pads are disposed in the first bezel region;
wherein the liquid crystal prism comprises a substrate, a plurality of electrode groups and a lead group, the plurality of electrode groups and the lead group are located on one side of the substrate, at least one of the plurality of electrode groups comprises a plurality of drive electrodes, the plurality of drive electrodes are located in the optical region and the non-optical region, the lead group is located in the non-optical region and comprises a plurality of leads, the plurality of drive electrodes and the plurality of leads are disposed in different layers, one of the plurality of drive electrodes is electrically connected to at least one of the plurality of leads, and different drive electrodes are electrically connected to different leads; and
wherein the liquid crystal prism further comprises an auxiliary lead group, at least a portion of the auxiliary lead group is located in the first bezel region, the auxiliary lead group comprises a plurality of auxiliary leads, and the plurality of leads are electrically connected to the bonding pads via the plurality of auxiliary leads, respectively.

2. The liquid crystal prism according to claim 1, wherein the plurality of auxiliary leads and the plurality of leads are disposed in a same layer.

3. The liquid crystal prism according to claim 2, wherein a portion of the drive electrode located in the first bezel region comprises a bridge, one end of the bridge is electrically connected to a lead among the plurality of leads, and the other end of the bridge is electrically connected to an auxiliary lead among the plurality of auxiliary leads.

4. The liquid crystal prism according to claim 3, wherein in a direction perpendicular to the substrate, a layer where the drive electrode is located is located between the substrate and a layer where the lead is located, or
wherein in a direction perpendicular to the substrate, a layer where the lead is located is located between the substrate and a layer where the drive electrode is located.

5. The liquid crystal prism according to claim 1, wherein one of the plurality of drive electrodes is electrically connected to at least one of the plurality of auxiliary leads, and different drive electrodes in a same electrode group are electrically connected to different auxiliary leads.

6. The liquid crystal prism according to claim 1, wherein the non-optical region further comprises a second bezel region located on a side of the optical region facing away from the first bezel region along a first direction;
a lead among the plurality of leads is electrically connected to a portion of a drive electrode located in the first bezel region, and/or a lead among the plurality of leads is electrically connected to a portion of a drive electrode located in the second bezel region; and
in the first bezel region, the auxiliary lead group is located between at least one lead group and a region where the bonding pads are located along the first direction.

7. The liquid crystal prism according to claim 6, wherein the auxiliary lead comprises a first line segment located in the first bezel region, the lead comprises a first lead electrically connected to the auxiliary lead, and the first lead comprises a second line segment located in the first bezel region; and
a number of drive electrodes electrically connected to the first line segment is less than a number of drive electrodes electrically connected to the second line segment.

8. The liquid crystal prism according to claim 7, wherein the first line segment and the second line segment extend along a second direction, wherein the first direction intersects the second direction.

9. The liquid crystal prism according to claim 7, wherein the lead further comprises a second lead electrically insulated from the first lead and comprising a third line segment located in the second bezel region, and the number of drive electrodes electrically connected to the first line segment is less than a number of drive electrodes electrically connected to the third line segment; and
the second lead comprises a fourth line segment located in the first bezel region, the third line segment is electrically connected to a corresponding one of the bonding pads via the fourth line segment, and along the first direction, the fourth line segment is located between the second line segment and the region where the bonding pad is located.

10. The liquid crystal prism according to claim 9, wherein the non-optical region further comprises a third bezel region and a fourth bezel region, the third bezel region and the fourth bezel region are located on two opposite sides of the optical region, and the third bezel region is connected to the first bezel region and the second bezel region; and
the first lead further comprises a fifth line segment located in the third bezel region and electrically connected to the second line segment, and the second lead further comprises a sixth line segment located in the fourth bezel region and electrically connected to the third line segment and the fourth line segment.

11. The liquid crystal prism according to claim 9, wherein in a direction perpendicular to the substrate, the fourth line segment overlaps the drive electrode.

12. The liquid crystal prism according to claim 1, wherein a same lead is electrically connected to two opposite ends of a drive electrode among the plurality of drive electrodes.

13. The liquid crystal prism according to claim 12, wherein the same lead forms a closed shape surrounding the optical region.

14. The liquid crystal prism according to claim 13, wherein the auxiliary lead group comprises a first auxiliary lead group and a second auxiliary lead group; and
along a second direction, the first auxiliary lead group is spaced apart from the second auxiliary lead group.

15. The liquid crystal prism according to claim 6, wherein spacing between adjacent leads in the first bezel region is less than spacing between adjacent leads in the second bezel region; and/or spacing between adjacent auxiliary leads in the first bezel region is less than spacing between adjacent leads in the second bezel region.

16. The liquid crystal prism according to claim 15, wherein the drive electrode is electrically connected to the lead via a first via in the first bezel region, the drive electrode is electrically connected to the lead via a second via in the second bezel region, and the drive electrode is electrically connected to the auxiliary lead via a third via in the first bezel region; and
a number of first vias connected to a same drive electrode is less than a number of second vias connected to the same drive electrode, and/or a number of third vias connected to a same drive electrode is less than a number of second vias connected to the same drive electrode.

17. The liquid crystal prism according to claim 15, wherein the spacing between the adjacent leads in the first bezel region is equal to the spacing between the adjacent auxiliary leads in the first bezel region.

18. The liquid crystal prism according to claim 1, wherein one of the plurality of auxiliary leads is electrically connected to one drive electrode,
and a plurality of drive electrodes electrically connected to auxiliary leads in a same auxiliary lead group are located in one or more of the plurality of electrode groups, or
wherein one of the plurality of auxiliary leads is electrically connected to at least two drive electrodes.

19. The liquid crystal prism according to claim 1, wherein the first bezel region further comprises an avoidance region, and along a direction perpendicular to the substrate, none of the plurality of drive electrodes, the plurality of leads and the plurality of auxiliary leads overlap the avoidance region; and
the liquid crystal prism further comprises a liquid crystal layer, a common electrode and a connector, the liquid crystal layer is located between the plurality of drive electrodes and the common electrode, one end of the connector is connected to the common electrode, and the other end of the connector is located in the avoidance region.

20. A display device, comprising a display panel and a liquid crystal prism,
wherein the liquid crystal prism comprises an optical region and a non-optical region located at a periphery of the optical region, wherein the non-optical region comprises a first bezel region located on one side of the optical region, and bonding pads are disposed in the first bezel region;
wherein the liquid crystal prism comprises a substrate, a plurality of electrode groups and a lead group, the plurality of electrode groups and the lead group are located on one side of the substrate, at least one of the plurality of electrode groups comprises a plurality of drive electrodes, the plurality of drive electrodes are located in the optical region and the non-optical region, the lead group is located in the non-optical region and comprises a plurality of leads, the plurality of drive electrodes and the plurality of leads are disposed in different layers, one of the plurality of drive electrodes is electrically connected to at least one of the plurality of leads, and different drive electrodes are electrically connected to different leads; and
wherein the liquid crystal prism further comprises an auxiliary lead group, at least a portion of the auxiliary lead group is located in the first bezel region, the auxiliary lead group comprises a plurality of auxiliary leads, and the plurality of leads are electrically connected to the bonding pads via the plurality of auxiliary leads, respectively.
